(19) United States
(12) Patent Application Publication
(10) Pub. No.: US 2021/0244110 A1
(43) Pub. Date: Aug. 12, 2021

(54) FAN ASSEMBLY FOR A MASK

(71) Applicant: KONINKLIJKE PHILIPS N.V., Eindhoven (NL)

(72) Inventor: Ruben Arnold Herman Reekers, Shanghai (CN)

(21) Appl. No.: 17/181,267

(22) Filed: Feb. 22, 2021

(30) Foreign Application Priority Data
Aug. 23, 2018 (CN) PCT/CN2018/102026
Jan. 7, 2019 (EP) 19150541.1

(51) Int. Cl. A41D 13/11; F24F 7/06; F24F 11/88; F24F 11/77

(52) U.S. Cl. CPC A41D 13/1107; F24F 11/77; F24F 11/88; F24F 7/065

(57) ABSTRACT

Presented is a fan assembly for attachment to a mask, comprising: a fan; a controller configured to change the drive signal of the fan when a trigger signal is received. Further, a mask comprising the fan assembly is presented.

### FIELD OF THE INVENTION

The present invention relates to protective masks, for example pollution or dust masks.

### BACKGROUND OF THE INVENTION

Currently, fan-assisted protective masks are available on the market.

Traditionally the fans of these masks are powered with a battery. When the battery level is low, the fan switches off or a LED indicates the low power level of the battery. The use of a LED to indicate the power level of the battery is not useful as the LED itself is not visible to the user when he/she is wearing the mask. As a result, the fan of the mask may switch off inadvertently due to a low battery level.

A solution is required which makes the user aware of battery level status. A solution to this problem would also be useful to provide other notifications to the user.

US20170189727A1 discloses systems and methods systems and methods for removing ultra-fine particles from air. In one implementation, a low power air purifying respirator is configured for filtering ultra-fine particles using a primary filter having a composite filter media, which may be pleated and may provide no outgassing. The respirator includes at least one fan providing positive pressure air flow to the primary filter at a low face velocity. The at least one fan may comprise a plurality of serially stacked, axial fans configured to increase air pressure without increasing flow. One or more safety valves are disposed along the air flow path to prevent back flow and carbon dioxide buildup during use. A user device may be in communication with a controller in the respirator to control the operations of the respirator. The respirator may be connected to a mask via a hose.

### SUMMARY OF THE INVENTION

In a first aspect of the invention, a fan assembly, e.g. for attachment to a mask, is presented, comprising: a fan; and a controller configured to change the drive signal of the fan when a trigger signal is received. When the controller receives the trigger signal, the drive signal to the fan is changed. Changing the drive signal results in a change of the rotation speed of the fan which is noticeable to the user when the fan assembly is attached to a mask. It is an advantage of the invention that the fan can be used as a feedback device for delivering notifications to the user. This means that no other devices or components are required which reduces cost. The drive signal of the fan may be the supply voltage to the fan. Thus, changing the drive signal may comprise changing the supply voltage to the fan.

According to an embodiment, the controller is configured to temporarily change the drive signal of the fan when the trigger signal is received. In this embodiment, when the trigger signal is received, the controller will change the drive signal of the fan for a pre-determined amount of time, e.g. for a few seconds. After the pre-determined time, the controller may be configured to deliver a drive signal to the fan similar to the drive signal that was provided before the trigger signal was received. It is an advantage of the invention that by changing the drive signal only temporarily, the notification provided by the fan to the user wearing the mask will be easier to be experienced by the user.

According to an embodiment, changing the drive signal comprises changing the rotation speed of the fan. Changing the drive signal of the fan is selected such that the resulting change of the rotation speed results in a noticeable change to the user, e.g. a noticeable change in provided air into the mask and thereby hitting the face of the user or sound or vibration produced by the fan. For instance, the trigger signal can be indicative of current battery level/power level, such as low battery. Here are a few examples (non-exhaustive) of how the fan speed can be manipulated when the low battery threshold is reached:

The fan is switched off (rotation speed=zero) for X amount of time, for example, 2 seconds, and then resumes at the same speed as before switching off.

The above action is repeated 1 or more times, to make it more noticeable for the user.

If the fan is not running at maximum speed, it can go to maximum speed and then switch off and behave in similar way as above.

Another method is varying the fan rotation speed very rapidly in such a way the it will be noticed by the user. For example, changing from the lowest possible speed or speed setting (if applicable) to the highest speed or speed setting (if applicable) in the shortest amount of time possible, which can be perceived as pulsating.

Above examples of the fan speeds are actually different patterns in which the fan can be rotated, such as intermittent high and low speed, or a high speed for a few seconds and then switching it OFF. These patterns in which the fan can be rotated are provided by a drive signal pattern. In other words, in various embodiments, the drive signal includes a drive signal pattern, which accordingly is executed by the controller to rotate the fan based on the pattern indicated by the drive signal pattern. To further clarify, the term “drive signal” is a signal to drive (rotate) the fan. The term “drive signal pattern” is a pattern in which the fan has to be rotated, which is provided by the signal. Few those patterns are provided as examples above.

Above examples can be used either alone or in combination.

The most suitable control method depends on various factors, most significantly the type of fan that is used, the vibration it causes and the structural properties of the mask assembly.

Though above examples are provided with trigger signal being indicative of low battery. These examples can also be used either alone or in combination in response to other type of trigger signals (examples of different type of trigger signals are provided later) as well.

Alternatively, if a pump is used, the amount of air provided into the mask or the amount of air expelled from the mask is changed by changing the drive signal. Similarly, changing the drive signal of the pump is selected such that the resulting change of the amount of air provided by the pump results in a noticeable change to the user, e.g. a noticeable change in provided air into the mask and thereby hitting the face of the user or sound or vibration produced by the pump.

According to an embodiment, changing the rotation speed comprises sequentially increasing and decreasing the rotation speed. If a pump is used, changing the rotation speed comprises increasing and decreasing the amount of air moved by the pump. It is an advantage of the invention that a pattern of increasing and decreasing air provided by the fan or pump will result in a notification that is easy to be recognized by the user.

According to an embodiment, the fan assembly further comprises: a battery for supplying power to the fan; and electronic circuitry for determining the power level of the battery, the electronic circuitry being configured to provide a trigger signal to the controller when the power level of the battery drops below a pre-determined power level. Thus, when the power level of the battery drops below a pre-determined power level, a trigger signal is supplied to the controller. Thereafter the controller changes the drive signal of the fan. In an implementation, the electronic circuitry for determining the power level of the battery may also be integrated into the controller. It is an advantage of the invention that the battery level is automatically checked and notified to the user without any intervention of the user. It is a further advantage that the power level is notified to the user before the battery is drained completely.

According to an embodiment, the electronic circuitry is configured to determine the power level of the battery from the rotation speed of the fan. The controller may also comprise this functionality instead of using separate electronic circuitry. It is an advantage of the invention that no costly electronics are required to determine the power level of the battery. If a pump is used, the power level of the battery may be determined from the volume of air moved by the pump, e.g. using a volumetric air flow sensor.

According to an embodiment, the trigger signal is a physiological signal from a user. The physiological signal may be a signal related to the heartrate, breathing rate or another signal originating from the body of the user. It is an advantage of the invention that a mask having such a fan assembly can be used during different activities of the user. For example, the mask can be used during sport activities whereby the user is notified of his or her breathing rate, heart rate or other physiological signals without the need of the user to actually consult another device such as a display which would interrupt his or her activity.

According to an embodiment, the trigger signal originates from a device external from the fan assembly. Such a device may be a smartphone, a communication or messaging device. According to an embodiment, the fan assembly comprising a wireless circuit for receiving the trigger signal wirelessly. The wireless circuit may also be integrated in the controller. For example, when a text message is received by the smartphone, the smartphone communicates this notification to the fan assembly wirelessly. The controller receives this notification and changes the drive signal of the fan accordingly. Hence, when a text message is received, the user experiences a notification in the form of a change of the rotation speed of the fan (or a change in the amount of air provided by the pump).

According to an embodiment, the fan assembly comprises a means for attaching the fan assembly to a mask.

According to an embodiment, the fan is a micro-fan. It is an advantage of the invention that the mask is device whereby all components can be attached to the mask whilst remaining portable and wearable.

According to an embodiment, the fan assembly comprises an air filter. This air filter may be a replaceable air filter capable of filtering out harmful pollutants from air, e.g. pollutants such as PM2.5 or pollutants related to traffic congestion among others. The air filter is positioned such that air imported by the fan into the mask is filtered.

According to an embodiment, the controller is configured to select a drive signal pattern from a plurality of different drive signals based on the type of received trigger signal. Thus, the controller is capable of generating different drive signals. Each drive signal relates to a type of trigger signal. For example, when a first type of trigger signal is received, the controller will generate a drive signal having a first drive signal pattern. When a second type of trigger signal is received, the controller will generate a drive signal having a second drive signal pattern, different from the first drive signal pattern. It is an advantage of the invention that different drive signal patterns allow different notifications to be delivered to the user using the same components. For example, the type of the trigger signal may be power level of a battery, a heart related signal from a heart monitoring device, a breathing rate related signal from a breathing rate monitoring device, etc. For this purpose, the trigger signal may include an identifier that allows the controller to identify the type of the trigger signal. The identifier may be an identifiable code in the data of the trigger signal.

In a second aspect of the invention a mask is presented, comprising: a mask body forming a mask chamber between the mask body and a user's face when the mask is worn; a fan assembly as described in the first aspect of the invention and any of its embodiments, attached to the mask body for ventilating the mask chamber.

According to an embodiment, the fan assembly is detachable from the mask body.

According to an embodiment, the mask or the fan assembly further comprises a vibrating component configured to vibrate when the trigger signal is received.

According to an embodiment, the vibrating component is configured to vibrate differently for different types of trigger signals whereby a particular vibration or vibration pattern is linked to a particular type of trigger signal. Thus, when a first type of trigger signal is received, the vibrating component will generate a vibration having a first vibrating pattern. When a second type of trigger signal is received, the vibrating component will generate a vibration having a second vibrating pattern, different from the first vibrating pattern. It is an advantage of the invention that different vibration patterns allow different notifications to be delivered to the user using the same component.

According to an embodiment, the mask or the fan assembly further comprises a sound generator configured to generate a sound when the trigger signal is received.

According to an embodiment, the sound generator is configured to generate different sounds for different types of triggers signals whereby a particular sound or sound pattern is linked to a particular type of trigger signal. Thus, when a first type of trigger signal is received, the sound generator will generate a sound having a first sound pattern. When a second type of trigger signal is received, the sound generator will generate a sound having a second sound pattern, different from the first sound pattern. It is an advantage of the invention that different sound patterns allow different notifications to be delivered to the user using the same component.

In a third aspect of the invention, a method for controlling a mask having a fan is presented, comprising: receiving a trigger signal; changing the drive signal of the fan when a trigger signal is received such that the change of the drive signal results in a noticeable change of the fan's rotation speed to the user.

According to an embodiment, the method comprises: determining the type of the trigger signal; and wherein the drive signal is selected from a plurality of different drive signals depending on the determined type of the trigger signal. This drive signal is then used to drive the fan as described in the first aspect of the invention. The type of the trigger signal may refer to the origin of the trigger signal. The origin may relate to the trigger signal being received from a particular electronic component or it may relate to a particular physiological signals. For example, the type of the trigger signal may be power level of a battery, a heart related signal from a heart monitoring device, a breathing rate related signal from a breathing rate monitoring device, etc. For this purpose, the trigger signal may include an identifier that allows the controller to identify the type of the trigger signal. The identifier may be an identifiable code in the data of the trigger signal.

According to an embodiment, the method further comprises changing the drive signal of the fan to a drive signal similar to the drive signal of the fan before the trigger signal was received, after a pre-determined amount of time. Thus, the fan is provided with a first (initial) drive signal; then the trigger signal is received which makes the system change the drive signal into a second drive signal, different from the first drive signal; after a pre-determined amount of time the drive signal is changed again to the first (initial) drive signal.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

In a further aspect of the invention, a computer program product comprising a computer executable program code is provided to perform the method of claims (as described above) when executed by a controller for controlling a fan, wherein the fan and the controller form a fan assembly.

It shall be understood that the fan assembly, the mask comprising the fan assembly, the method for controlling the fan and the corresponding computer program product claims will have similar advantages.

Preferred embodiments of the invention are defined in the dependent claims. It shall be understood that the mask comprising the fan assembly, the method for controlling the fan and the corresponding computer program product claims can have similar and/or identical preferred embodiments/advantage(s) as the claimed the fan assembly, in particular as defined in the dependent claims and as disclosed herein.

### BRIEF DESCRIPTION OF THE DRAWINGS

FIG. 1 illustrates a user wearing a mask having a fan assembly

FIG. 2 illustrates a diagram of a method for operating a mask or fan assembly

FIG. 3 illustrates a diagram of a method for operating a mask or fan assembly

The drawings are only schematic and are non-limiting. In the drawings, the size of some of the elements may be exaggerated and not drawn on scale for illustrative purposes.

Any reference signs in the claims shall not be construed as limiting the scope. In the different drawings, the same reference signs refer to the same or analogous elements.

### DETAILED DESCRIPTION OF THE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In a first aspect of the invention, a fan assembly 100 for attachment to a mask 200 such as a protection mask is presented. The fan assembly 101 comprises a fan 101 or a pump for ventilating the mask. Ventilating the mask improves the breathing comfort of the mask. The fan assembly 100 further comprises a controller 102 that is configured to change or adapt the drive signal of the fan 101 when a trigger signal is received. In other words, a drive signal—different from the drive signal that is used to ventilate the mask—is selected by the controller 102 when the trigger signal is received. The fan assembly 100 is depicted in FIG. 1.

When a mask is worn by a user, indicating certain signals to the user is complex as any indicator positioned on the mask is difficult to be viewed by the user during usage of the mask. For example, a colour change of LEDs positioned on the mask is difficult to be noticed when the mask is worn. The fan assembly as presented solves this problem by using the fan to provide a feedback signal to the user when a trigger signal is received. The fan assembly functions as a tactile feedback device to the user. The drive signal is changed in such a manner that the change of the drive signal corresponds to a change of the rotation speed of the fan which is noticeable to the user. It is an advantage of the invention that the user doesn't need to take off the mask to become aware of certain notifications such as low battery level or other notifications such as gas pollutant levels in air surrounding the user. This increases the usability of the mask.

The fan may be a micro-fan, mini-fan or miniature fan, capable of ventilating the mask. The fan is to be attached to a mask. Hence, the size of the micro-fan is such that it may be integrated in a stand-alone mask, without the fan being connected to the mask via a hose or without the fan needing a different support apart from being coupled, integrated or attached to the mask. Alternatively, the fan may also be a pump such as a micro-pump. Throughout this description, the words fan and pump may be interchanged. The fan or the pump may be referred to as a ventilating unit.

The fan may be a fan that imports air into the mask when the fan assembly is attached to a mask. The fan may also be a fan that expels air from the mask when the fan assembly is attached to a mask. The fan may also be a bi-directional fan capable of importing air into the mask or expelling air from the mask depending on the drive signal provided to the fan. The fan assembly may be configured such that the fan drive signal follows the breathing cycle of the user. The mask may also comprise two fans whereby a first fan is configured to expel air from the mask chamber, e.g. when the user exhales; and whereby a second fan is configured to import air into the mask chamber, e.g. when the user inhales. The mask may also comprise two fans whereby both fans are configured to expel air from the mask chamber, e.g. when the user exhales. The mask may also comprise two fans whereby both fans are configured to import air into the mask chamber, e.g. when the user inhales. Determining whether the user inhales and/exhales may be done by additional components inside the mask, such as pressure, temperature and/or humidity sensors.

The controller may be a processor having an input port that is continuously monitoring the presence of a trigger signal at the input port. The controller is electrically or wirelessly coupled to the fan and controls the fan by providing a drive signal to the fan. Intermediate electronics may be present between the fan and the controller. The controller is configured such that when a trigger signal is received, the drive signal is changed. The controller may be physically located on the fan.

According to an embodiment, the controller is configured to temporarily change the drive signal of the fan when the trigger signal is received. Changing the drive signal comprises changing the rotation speed of the fan. The controller may be configured such that the drive signal is changed only during a pre-determined time period. For example, during a few seconds the drive signal of the fan is changed. The change of the drive signal should be such that providing the changed drive signal to the fan is noticeable to the user in the form of an increased and/or decreased air flow towards the face of the user. The controller may be configured such that the drive signal is changed multiple times sequentially with a pre-determined time period in between each change.

According to an embodiment, the controller is configured to apply a changing drive signal pattern to the fan when a trigger signal is received. In other words, the controller is configured to supply a drive signal to the fan that changes over time. For example, the controller is configured to supply a drive signal that changes over a pre-determined time period.

According to an embodiment, changing the rotation speed comprises increasing and/or decreasing the rotation speed.

According to an embodiment, the controller is configured to select a drive signal or drive signal pattern from a plurality of different drive signals or drive signal patterns based on the type of trigger signal received. For this purpose, the controller may comprise a memory comprising a plurality of different drive signal patterns linked to different trigger signal types. When the controller receives the trigger signal, the controller checks in the memory which drive signal pattern corresponds to the type of trigger signal received and then supplies the selected drive signal pattern to the fan. Thus, for different types of trigger signals, the fan will behave differently. It is an advantage of the invention that the fan can be used to alert a user for multiple types of indicators while using the same fan. Thus, there is no need to implement different indicators for different signal types. This reduces cost.

According to an embodiment, the fan assembly further comprises a battery for supplying power to the fan. The battery may be present on the fan assembly. The battery may be fixed inside the fan assembly. The battery may also be changeable. The fan assembly further comprises electronic circuitry coupled to the battery, for example a micro-chip, for determining the power level of the battery. The electronic circuitry is configured to provide the trigger signal to the controller when the power level of the battery drops below a pre-determined power level. According to an embodiment, the electronic circuitry is configured to determine the power level of the battery from the rotation speed of the fan. In such an embodiment, the fan comprises one or more sensors (the electronic circuitry) capable of sensing the rotation speed of the fan.

According to an embodiment, the trigger signal is a physiological signal from a user. The trigger signal may be a signal external from the fan assembly of the mask. For example, the trigger signal may be the heartbeat of a user or any other physiological signal. As described in an embodiment above, based on the type of physiological signal, the controller may generate a different drive signal to the fan. Physiological signals may be, not limited to, heart rate, breathing rate, brain electrical activity, etc. The controller may be configured such that when a first physiological signal of a user exceeds a certain threshold, the controller generates a first drive signal pattern to the fan. The controller may be further configured such that when a second physiological signal of the user exceeds a certain threshold, the controller generates a second drive signal pattern, different from the first drive signal pattern, to the fan. This way the user can differentiate between notifications related to different physiological signals through the behaviour of the fan.

### Example

The controller is configured such that when the heart rate of a user exceeds a certain threshold, the controller generates a first drive signal pattern to the fan. The controller is further configured such that when the breathing rate of the user exceeds a certain threshold, the controller generates a second drive signal pattern, different from the first drive signal pattern, to the fan. Because of the different drive signal patterns provided to the fan, the user can differentiate whether his heart rate or his breathing rate exceeded a threshold without removing the mask.

According to an embodiment, the controller is capable of receiving the trigger signal wirelessly, for example, the controller comprises a wireless communication chip. Wireless sensors worn by a user, e.g. on his/her body, may be connected with the controller and provide a trigger signal to the controller.

According to an embodiment, the fan assembly comprises a wireless circuit for receiving data wirelessly, coupled to the controller. The wireless circuit is configured to analyze received data and when required based on the analysis, provide a trigger signal to the controller. For example, the wireless circuit receives physiological data from one or more sensors. When required, for example when a threshold value is reached or when a certain event is detected in the physiological data, a trigger signal is generated based on the analysis of the physiological data.

According to an embodiment, the fan assembly comprises a mechanical means for attaching the fan assembly to a mask. The means may be a connector that allows attaching the fan assembly to the mask. The means may be a clip-on or click-on mechanism that allows easy attaching and detaching of the fan assembly to the mask.

According to embodiments, the fan assembly comprises an air filter for filtering air that is imported in the mask.

In a second aspect of the invention a mask 200 is presented, comprising: a mask body 201 forming a mask chamber 202 between the mask body 201 and a user's face 10 when the mask 200 is worn. The mask body 201 may comprise an air filter or may be manufactured from a material that filters particles such as pollutants from air. The mask comprises the fan assembly 100 as described in the first aspect of the invention and any of its embodiments. The fan assembly 100 is attached or coupled to the mask body 201 such that the mask chamber 202 is ventilated when the fan 101 is active. The fan assembly 101 may be detachably attached to the mask body 201. This is depicted in FIG. 1.

The mask body may be manufactured from a rigid or a semi-rigid material, e.g. a plastic material. The mask body may be manufactured from a material that is not permeable to air. In embodiments where the mask body material is a non-air-permeable material, the fan comprises an air filter that filters the air being imported into the mask chamber by the fan.

According to an embodiment, the fan assembly further comprises a vibrating component configured to vibrate when the trigger signal is received. This vibrating component may also be present on the mask, e.g. on the mask body. The vibrating component is coupled to the controller whereby the controller drives the vibrating component when a trigger signal is received. The vibrating device may be a piezoelectric vibrating device.

According to an embodiment, the controller is configured to change the drive signal of the fan or activate the vibrating component depending on the type of the trigger signal received. For example, when a first type of trigger signal is received, the drive signal of the fan is changed as described in any of the embodiment above. When a second type of trigger signal—different from the first type of trigger signal—is received, the vibrating component is activated. The controller may also be configured to activate the vibrating component such that the vibration signal produced by the vibrating component is different for different types of trigger signals, e.g. different vibrating patterns.

According to an embodiment, the fan assembly or the mask further comprises a sound generator configured to generate a sound when the trigger signal is received. This sound generator may also be present on the mask, e.g. the mask body. The sound generator is coupled to the controller whereby the controller drives the sound generator when a trigger signal is received.

According to an embodiment, the controller is configured to change the drive signal of the fan or activate the sound generator depending on the type of the trigger signal received. For example, when a first type of trigger signal is received, the drive signal of the fan is changed as described in any of the embodiments above. When a second type of trigger signal—different from the first type of trigger signal—is received, the sound generator is activated. The controller may also be configured to activate the sound generator such that the sound signal produced by the vibrating component is different for different types of trigger signals, e.g. different sounds, e.g. different patterns of sounds.

According to an embodiment, the fan assembly of the mask comprises a gas sensor. The gas sensor is coupled to the controller and generates a trigger signal to the controller. The trigger signal may be related to a certain gas pollutant concentration threshold that is reached.

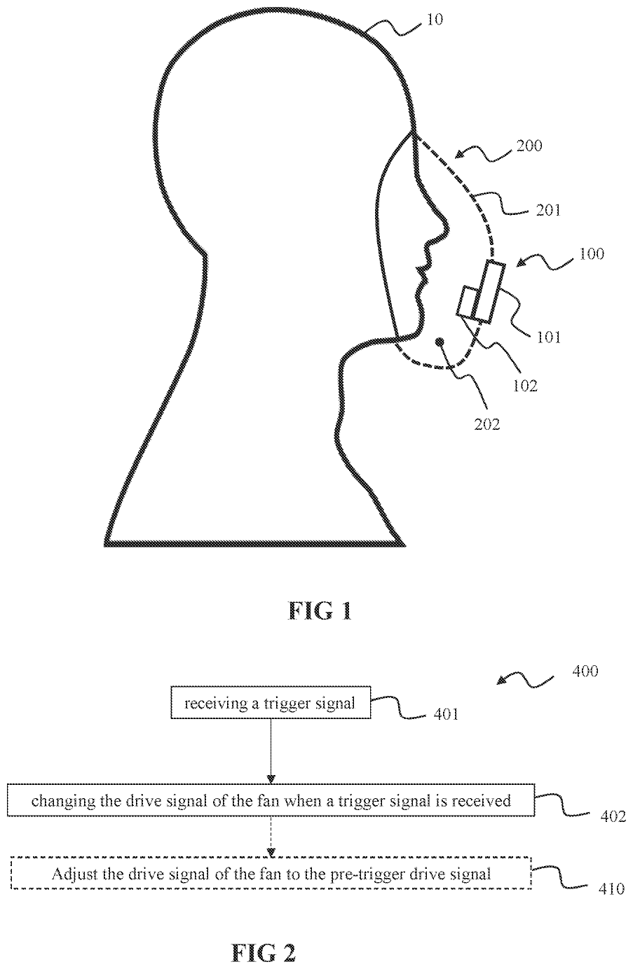

In a third aspect of the invention, a method 400 for controlling a fan is presented. The method controls a fan which is coupled to a mask and provides a way of indicating events to a user wearing the mask. The method comprises: receiving a trigger signal 401; changing the drive signal of the fan when a trigger signal is received 402. This is depicted in FIG. 2. When the fan is coupled to a mask, the change of the drive signal results in a noticeable change of the fan's rotation speed to the user. The noticeable change may be the result of a certain drive signal pattern that is supplied by the controller to the fan. The result of changing the drive signal is that the rotation speed of the fan changes. For example, the speed increases or decreases. For example, the speed is increased to the maximum speed. For example, the speed is increased and decreased.

In an embodiment, changing the drive signal may be temporarily. For example, after a pre-determined amount of time, e.g. after a few seconds, the drive is signal is changed again to the original drive signal 410, the original drive signal being the drive signal before the trigger signal was received. Thus the system may keep track of drive signals provided to the fan.

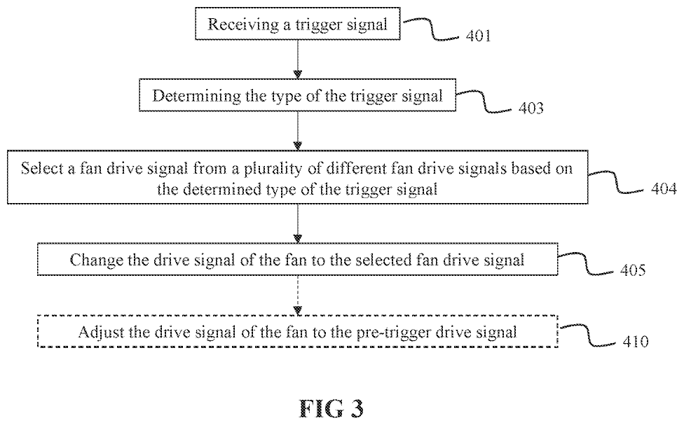

According to an embodiment, the method may further comprise: determining the type of the trigger signal, and selecting from a plurality of different drive signals the drive signal for the fan corresponding to the determined type of the trigger signal. For example, each drive signal may have a different pattern or a different duration. The drive signal may be selected from a look-up table that contains different types of trigger signals and different drive signal patterns. Each trigger signal type is linked to a certain drive signal pattern. The selected drive signal is then used to drive the fan. This is depicted in FIG. 3.

After changing the drive signal, the system returns to either the pre-trigger state or an adjusted state after a pre-determined amount of time, e.g. a few seconds. For example, the system may adjust the drive signal of the fan to a pre-determined drive signal, whereby the pre-determined drive signal may be the drive signal of the fan before the trigger signal was received. This is depicted in FIG. 3.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. Furthermore, any patent document or a publication mentioned herein is hereby incorporated by reference.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A fan assembly, comprising:
a fan;
a controller configured to change the drive signal of the fan when a trigger signal is received, wherein the controller is configured to temporarily change the drive signal of the fan when the trigger signal is received, wherein changing of the drive signal comprises changing the rotation speed of the fan, characterized in that the controller is configured to temporarily change the drive signal of the fan when the trigger signal is received.

2. The fan assembly according to claim 1, wherein changing the drive signal comprises providing a changing drive signal pattern to the fan.

3. The fan assembly according to claim 1, wherein the controller is configured to select a drive signal pattern from a plurality of different drive signal patterns based on the type of received trigger signal.

4. The fan assembly according to claim 1, further comprising:
a battery for supplying power to the fan;
electronic circuitry for determining the power level of the battery, configured to provide a trigger signal to the controller when the power level of the battery drops below a pre-determined power level.

5. The fan assembly according to claim 4, wherein the electronic circuitry is configured to determine the power level of the battery from the rotation speed of the fan.

6. The fan assembly according to claim 1, wherein the trigger signal is a physiological signal from a user.

7. The fan assembly according to claim 1, further comprising a means for attaching the fan assembly to a mask.

8. The fan assembly according to claim 1, further comprising:
a vibrating component configured to vibrate when the trigger signal is received; and/or
a sound generator configured to generate a sound when the trigger signal is received.

9. The fan assembly according to claim 1, comprising a wireless circuit for receiving wireless data, coupled to the controller.

10. A mask, comprising:
a mask body forming a mask chamber between the mask body and a user's face when the mask is worn;
a fan assembly according to claim 1, attached to the mask body for ventilating the mask chamber.

11. A method for controlling a fan, comprising:
receiving a trigger signal;
temporarily changing the drive signal of the fan when a trigger signal is received, wherein changing of the drive signal comprises changing the rotation speed of the fan.

12. The method according to claim 11 wherein changing the drive signal comprises providing a changing drive signal pattern to the fan.

13. The method according to claim 12, comprising:
determining the type of the trigger signal; and
selecting the drive signal pattern of the fan from a plurality of different drive signal patterns depending on the determined type of the trigger signal.

14. The method according to claim 11, further comprising changing the drive signal of the fan to a drive signal similar to the drive signal of the fan before the trigger signal was received, after a pre-determined amount of time.

15. A computer program product comprising computer executable program code to perform the method of claim 11 when executed by a controller for controlling a fan, wherein the fan and the controller form a fan assembly.
